(19) United States
(12) Patent Application Publication
(10) Pub. No.: US 2014/0236454 A1
(43) Pub. Date: Aug. 21, 2014

(54) Control Device for a Motor Vehicle and Method for Operating the Control Device for a Motor Vehicle

(71) Applicants: Stefan Mattes, Stuttgart (DE); Stefan Jansen, Pforzheim (DE); Susanne Schild, Gaertringen (DE); Norbert Kurz, Stuttgart (DE); Volker Entenmann, Affalterbach (DE)

(72) Inventors: Stefan Mattes, Stuttgart (DE); Stefan Jansen, Pforzheim (DE); Susanne Schild, Gaertringen (DE); Norbert Kurz, Stuttgart (DE); Volker Entenmann, Affalterbach (DE)

(73) Assignee: Daimler AG, Stuttgart (DE)

(21) Appl. No.: 14/343,681

(22) PCT Filed: Sep. 6, 2012
(86) PCT No.: PCT/EP2012/003732

§ 371 Date: Mar. 7, 2014

(30) Foreign Application Priority Data
Sep. 8, 2011 (DE) 10 2011 112 565.9
Sep. 8, 2011 (DE) 10 2011 112 567.5

(51) Int. Cl. F02D 28/00

(52) U.S. Cl. CPC F02D 28/00; F02D 2200/60
USPC 701/102

(57) ABSTRACT

A control device for a motor vehicle, with which a control input carried out by at least one finger can be detected, includes a transmitter unit to transmit a signal to the finger, a receiving unit to receive a signal reflected from the finger, a control surface element, which is able to be spatially positioned in relation to the finger to carry out an operational entry, and an evaluation unit to determine a spatial position of the finger in relation to the control surface element using the received signal.

### BACKGROUND AND SUMMARY OF THE INVENTION

Exemplary embodiments of the invention relate to a control device for a motor vehicle, with which a control input carried out by at least one finger is able to be detected, and a method to operate the control device for a motor vehicle, with which a control input carried out by at least one finger is detected in relation to a control surface element.

Modern motor vehicles comprise control devise such as touch pads or touch screens. These control devices are operated by a control input carried out by an operator using at least one finger. Thus, corresponding functional units of the motor vehicle, such as, for example, the navigation system, data connections, and entertainment and information systems of the motor vehicle or similar, can be operated. The operator or the vehicle passenger must familiarize themselves with the operating mode of the control device in order to orient themselves with this. As more and more functional units of the vehicle can be controlled with one control device in modern motor vehicles, such an operating mode can be very complex and incomprehensible for the operator.

If corresponding touch pads are used as a control device in order to be able to control the corresponding functional units of the motor vehicle, these touch pads are operated with a finger. Most touch pads only recognize the finger if it touches the operating surface of the touch pad. Therefore, these touch pads can only determine a two-dimensional coordinate of the finger. Some touch pads also recognize the finger if it hovers a few millimeters above the surface of the touch pad. These touch pads, however, also only determine a two-dimensional coordinate for the hovering finger. The exact distance of the finger from the surface of the touch pad cannot be calculated.

Almost all touch pads used today use a capacitive sensor system. This generally consists of a grid of sensor electrodes and an evaluation unit, which determines the capacities of the sensor electrodes. If a finger touches the surface of the touch pad, the sensor system registers the capacity change of the sensor electrodes and determines the position of the finger by means of these measured values. In the case of these touch pads, the two-dimensional coordinate of the finger can no longer be determined if the finger leaves the surface of the touch pad. If this happens while driving due to a vehicle movement, the control input based on the evaluation of the finger movement is interrupted. In the case of poor road conditions, but also in the case of an intentional removal of the finger from the screen, a continued movement or a continued touching of the finger to the surface, it can easily occur that the distance of the finger from the surface of the touch pad is clearly larger than a few millimeters. In these cases, the finger can no longer be detected by means of the touch pad. The operating procedure is interrupted.

With information about the two-dimensional position of the finger on the operating surface of the touch pad, only movements of the finger in a plane for operation entries can be evaluated. If, for example, a larger degree of operating freedom is needed, additional entries must be effected in parallel to the movement of the finger. An example of this is the movement of a mouse pointer, which is depicted on a display element, through a corresponding movement of the finger. Through a corresponding operation of an additional key, a corresponding selection element, on which the pointer is positioned, can be marked. In order to displace the marked selection element, the additional key must be clicked continuously and at the same time the finger is moved on the surface of the touch pad. Otherwise it cannot be differentiated whether only the mouse pointer should be moved by the movement of the finger on the surface of the touch pad, or if the marked object should be moved by means of the mouse pointer. Such operating entries with parallel operational actions require high levels of coordination from the user. During the drive, these are both linked to a high level of distraction and are difficult to carry out due to the movement of the vehicle.

Thus, exemplary embodiments of the present invention provide a control device for a motor vehicle and a method to operate the control device for a motor vehicle, by means of which a simple and efficient operability is permitted.

According to a first aspect, a control device for a motor vehicle, with which a control input carried out by at least one finger is able to be detected, has a transmitter unit to transmit a signal to the finger, a receiving unit to receive the signal reflected by the finger, a control surface element, in relation to which the finger is able to be spatially positioned to carry out a control input, and an evaluation unit to determine a spatial position of the finger in relation to the control surface element by means of the received signal.

Thus, a control input carried out by a finger can also be detected with the control device if the finger is not placed on the control surface element. The signal transmitted by the transmitter unit is reflected by the finger and received by the receiving unit. The evaluation unit then calculates the spatial coordinates of the finger from the sensor signals. This enables the finger to trace at a previously defined distance, which, for example, can amount to several centimeters, and to determine its three-dimensional position. Herein, the position of the finger is then also calculated if the finger is removed from the control surface element during the operating procedure. Thus, a control input carried out by the finger can be more reliably detected by the control device.

Through the continuous detection of the position of the finger, in the state in which it is removed from the control surface element and a corresponding visualization on a display element allocated to the control device, the user can also better coordinate their finger movement and position a cursor or pointer depicted on the display element more exactly. The detection of the position of the finger represents an additional degree of freedom, which can be used for the function control. Thus, for example, a three-dimensional menu control can be enabled.

According to one embodiment, the control surface element is permeable for the signal and the transmitter unit and the receiving unit are arranged on a side of the control surface element facing away from the finger. The control device preferably comprises one closed operating surface in the form of a control surface element. The transmitter unit and the receiving unit are arranged under this control surface element. In order to be able to detect the position of the finger over the control surface element using the transmitter unit and the receiving unit, the control surface element has a high degree of transmission in a wavelength range of the signal. Thus, the signal, which penetrates the control surface element twice on its way from the transmitter unit to the finger and back to the receiving unit, is not deflected or distorted. In this way, the spatial position of the finger can be determined particularly precisely.

According to a further embodiment, the transmitter unit transmits light, in particular in the infrared wavelength range, as the signal. The use of light in the infrared wavelength range has the advantage that the control surface element can be designed such that it is not transparent for the human eye. Thus, the user cannot see the technology arranged behind the control surface element. Therefore, the outward appearance of the control device can be embodied with a higher level of quality. A corresponding infrared light can be used as a transmitter unit and a corresponding infrared sensor system can be used as a receiving unit. The control surface element should be formed such that it has a degree of transmission that is very low in the visible wavelength range and very high in the infrared range. Additionally, the use of a corresponding infrared sensor system has the advantage that this is only slightly influenced by the ambient light. Therefore, the finger can be determined particularly exactly and reliably in relation to the control surface element.

According to a further embodiment, the position of the finger is able to be determined by the evaluation unit by means of a transmission time of the signal. The receiving unit can be formed as a so-called depth camera. Such a depth camera generally has only one lens. A special image sensor calculates proximity information for each image pixel using the transmission time measurement of the light, which is transmitted by the transmitter unit, which, for example, can be formed as a corresponding lighting unit, and is reflected by the surroundings. Through the evaluation of the pixel-free proximity information, the three-dimensional position of the finger can be determined particularly exactly.

According to a further embodiment, the position of the finger is also able to be determined by the evaluation unit by means of an intensity of the received signal. Likewise, a so-called mono camera can be used to determine the position of the finger. This measures the intensity of the reflected light pixel by pixel with its sensor. If a finger is located on or over the control surface element, the three-dimensional position of the finger can be determined through the evaluation of the intensity distribution, as the amplitudes and the shape of the intensity distribution correlate with the distance of the finger from the operating surface. This enables the position of the finger to be three-dimensionally detected in a simple manner.

According to a further embodiment, the control device has at least two receiving units, which are arranged at a distance in a direction of extension parallel to the main direction of extension of the control surface element. The receiving unit can also be formed as a stereo camera, which consists of two lenses and image sensors, which capture the finger from different perspectives. A three-dimensional position of the finger can be determined by offsetting the two images using the known distance of the sensors from one another. The methods and algorithms necessary for this are known, whereby the position of the finger can be determined without additional effort.

According to one embodiment, the control device has a plurality of transmitter units and a plurality of receiving units, which are arranged in a first direction of extension and a second direction of extension that is perpendicular to first and is in parallel to the main direction of extension of the control surface element. A discreetly constructed camera can likewise be used for the three-dimensional detection of the finger. Such a discreetly constructed camera generally consists of infrared transmitters and infrared receivers arranged in a grid-like manner on a circuit board. The infrared transmitters can, for example, be formed as a corresponding lighting unit or light diode. The infrared receivers can be formed as corresponding infrared sensors or as photo diodes. Through a suitable controlling of the transmitter units and the receiving units, the intensity of the reflected light can be measured pixel-by-pixel, wherein the pixels are defined according to the type of controlling through the grid network of the transmitter units or of the receiving units. The determination of the three-dimensional position of the finger occurs, as in a mono camera, by means of the distribution of the intensity of the reflected light, wherein the coarse resolution caused by the discreet construction can be compared by suitable interpolation of the measured data. Through the particularly flat construction of the discreet camera, small changes to the distance of the finger from the control surface element can already lead to a large alteration of the sensor signal, such that the proximity determination is exact and at a particularly high resolution.

According to a further embodiment, the control device has a sensor unit with which a touching of the control surface element with the finger is able to be detected. In all previously described combinations of transmission and receiving units, the exactness of the three-dimensional finger position determination can be increased by the touching of the control surface element by the finger being detected with an additional sensor system. The sensor system can, for example, be formed as a capacitive sensor. As the geometry of the control surface element is known, the proximity coordinates of the finger can be calibrated in the case of touching. Here, possible uncertainties in the proximity determination, which can result, for example, from a different reflective behavior of different fingers, can be counteracted.

According to a further embodiment, the control device has an actuator, with which a haptic signal is able to be transmitted to the finger touching the control surface element. The control device can additionally have corresponding actuation haptics. Therein, the user can trigger a corresponding function by exerting a trigger force on the control surface element. As a reaction to this, a haptic response is produced, in that the control surface element vibrates. Either a permanently working mechanical haptic mechanism (e.g. a micro switch) or a controllable electromechanical haptic mechanism (e.g. a distance sensor in combination with an electromagnetic actuator) can be used for this. In the second case, the actuation haptic can be switched on and off depending on the operating context and different haptic effects can be produced through a different controlling of the actuator. Thus, the operation of the control device can be enabled more reliably.

According to a further embodiment, the transmitter unit and the receiving unit are able to be activated depending on a signal of the sensor unit to determine the position of the finger. Additionally, the function of the control device can be improved by the three-dimensional position of the finger only being calculated after an initial touching of the control surface element with the finger. Without this condition, an intended operation and an otherwise motivated finger movement over the control surface element cannot be differentiated between exactly, such that functions can be triggered unintentionally. Furthermore, after the initial touching of the work surface element, an algorithm can be started that tests the measured finger position for plausibility by means of a model of the possible finger movements and flattens the measured values (tracking algorithm). In this way, the operation of the control device can be designed more reliably.

Likewise, the three-dimensional position of several fingers at the same time can be determined. The evaluation algorithms are correspondingly adapted to this.

According to a second aspect, a method to operate a control device for a motor vehicle, with which a control input carried out by at least one finger is detected in relation to a control surface element, wherein, in a first operating mode, an operation is carried out with the control input by means of contents specifically depicted on a display element allocated to the control device, has a provision of at least one second operating mode of the control device and such a selection of one of the operating modes that the content is specifically depicted on the display element corresponding to the selected operating mode of the control device.

The present method relates to a control device, as was previously specified, with which the position of a finger, with which a control input is carried out, is able to be detected three-dimensionally in relation to a control surface element. This means that the finger must not necessarily be applied to the control surface element in order to carry out a control input. The finger can also be positioned at a previously defined distance, which can, for example, amount to a few centimeters.

Through the use of such a control device, further concepts for the operation arise. Thus, it is possible to produce a highly flexible concept in which several operating modes are used practically. The respective operating modes can, for example, be correspondingly selected by a user. Depending on the selected operating mode, a corresponding content is depicted on a display element, which is allocated to the control device. Thus, a particularly simple and flexible operation of a control device for a motor vehicle can be enabled.

According to one embodiment, in a first operating mode, a selection element depicted on the display element is selected through a swipe movement of the finger carried out on the control surface element in a direction of the selection element. In this operating mode, for example, four or eight selection elements or menu entries are depicted on the display element. In order to select one of these menu entries, the operator carries out a corresponding swipe movement on the control surface element with their finger, wherein the swipe movement is directed in the direction of the menu entry or the selection element. Thus, there is no need for a further confirmation of the selection of the menu entry.

Additionally, gestures across all concepts can be recognized in this first operating mode. With such a gesture across all concepts, a level, for example, can be returned to in the contents depicted on the display element in the operating menu. This can, for example, be enabled through the quick implementation of a circular movement on the control surface element with the finger. Here, for example, a circular path can be described with the finger, which comprises at least one angle of 240°. Likewise, in the first operating mode, the implementation of a gesture across all concepts is conceivable, with which the operator effects the depiction of a main menu or a first level of an operating menu on the display element. This can, for example, be achieved through a quick double tap with the finger on the control surface element. These gestures across all concepts can be depicted, for example, on a region of the display element in the form of corresponding symbols. Thus, a control device can be operated particularly simply and intuitively.

According to a further embodiment, in a second operating mode, a pointer is positioned in a region allocated to a selection element by moving the finger on the control surface element and the selection element is selected by pressing the control surface element with the finger. In this operating mode, a corresponding cursor can be depicted on the display element, which is controlled analogically by a movement of the finger on the control surface element. In this case, analogically means that a position of the pointer or the cursor on the display element is allocated in each position on the control surface element. The pointer is thus moved analogically to the finger. To select a corresponding selection element, the pointer or cursor is moved over the corresponding selection element and a corresponding pressure with the finger on the control surface element is used to select. The control surface element of the control device is therefore designed to be pressure sensitive or has a corresponding switch function. Here it is likewise provided that the pointer also remains visible on the display element, if the finger is not located on the operating element but over the operating element. Thus, a stable, smooth depiction of the pointer is achieved on the display element, whereby the operating certainty is in turn increased.

In this second operating mode, swiping gestures that are carried out with the finger can likewise be recognized. Thus, for example, in a vertical list, it is possible to switch to another category of list entries through a swipe movement to the left or to the right. Likewise, for example, a list can be navigated via swiping gestures. Gestures across all concepts can also be recognized in this second operating mode. Thus, for example, the main menu can be brought up through a quick double tap with the finger on the control surface element. This operating mode enables a simple and intuitive operation of the control device.

According to a further embodiment, in the second operating mode, characters are inserted into a text processing program of the control device through the movement of the finger on the control surface element. In a corresponding writing mode, handwritten characters that are carried out with the finger on the control surface element can be recognized. Thus, for example, corresponding messages can be created by the user in a particularly simple manner. Additionally, this character recognition can be used in order to, for example, insert corresponding destinations into a navigation system of the motor vehicle. Thus the operation of the operating element can be clearly simplified.

According to a further embodiment, in a third operating mode of the control device, the selection elements depicted on the display element are depicted perspectively and a pointer depicted on the display element is, in this depiction, varied relating to a height depending on the distance of the finger from the control surface element.

In the third operating mode of the control device, an operational action is additionally considered depending on the distance of the finger from the control surface element. Through the perspective depiction of the selection element and the pointer, a particularly simple operation can be enabled. Here it is likewise conceivable that corresponding selection elements can be selected in this three-dimensional depiction and removed or displaced. The distance of the finger in relation to the control surface element can be depicted on the display element by the distance of the selection element or the pointer to a corresponding reference surface. Here, a corresponding shadow of the selection element or of the pointer can be inserted, which represents the distance. Here, corresponding music covers can also be particularly simply selected in an entertainment system of the motor vehicle. The perspectively depicted music covers can be pressed downwards analogically to the distance of the finger from the operating surface and thus a particularly simple and intuitive operation can be enabled.

According to a further embodiment, in the third operating mode, the size of the region depicted on the display element is changed depending on the distance of the finger to the control surface element. In this operating mode, the pointer or cursor can be moved over a corresponding display on the display element, wherein the distance of the finger from the control surface element determines the magnification factor of the respective display. Thus, for example, a corresponding map section of a navigation system, which is depicted on the display element, is correspondingly magnified. Thus, a simple operation of the control device can be achieved.

According to a further embodiment, in the third operating mode, at least one first functional unit of the motor vehicle is operated depending on the distance of the finger from the control surface element and at the same time at least one second functional unit of the motor vehicle is operated depending on a movement of the finger along a direction of extension in parallel to the main direction of extension of the control surface element. Quantitative adjustments can herein occur in parallel in three dimensions. For example, in the adjustment of an entertainment system of the motor vehicle, the fader/balance adjustments can be operated depending on the movement of the finger along the main direction of extension of the control surface element and the volumes are adjusted depending on the distance of the finger from the control surface element. The final confirmation of this adjustment can, for example, occur via an additional key, which, for example, is actuated with the other hand, or it can be accepted automatically after a predetermined amount of time. Thus, a corresponding control device can be particularly simply and quickly operated.

According to a further embodiment, in the third operating mode, at least a first of the selection elements is operated, in the case that the finger is positioned on the control surface element and/or at least one second selection element is operated, in the case that the finger is positioned at a predetermined distance from the control surface element. In this operating mode, an extended keyboard can be enabled. The keyboard depicted on the display element can, for example, be divided into two regions. Here, a first region of the keyboard can be operated if the finger is positioned on the control surface element and the second part of the keyboard can be operated in that case that the finger is lifted from the control surface element. Numbers or seldom used characters can exist in the second region of the keyboard. Thus, no switches between different displays is required during text entry.

### BRIEF DESCRIPTION OF THE DRAWING FIGURES

The present invention is hereafter explained in more detail by exemplary embodiments with reference to the enclosed drawings.

Here are shown:

FIG. 1 a schematic depiction of a control device according to a first embodiment in a sliced side view,

FIG. 2 a second embodiment of the control device,

FIG. 3 a third embodiment of the control device,

FIG. 4 a fourth embodiment of the control device,

FIG. 5 a three-dimensional depiction of a measurement signal received using the control device,

FIG. 6 a display of a display element of a control device in a first operating mode,

FIG. 7 a display of a display element of a control device in a second operating mode,

FIG. 8 a display of a display element of a control device in a third operating mode, and

FIG. 9 a display of a display element of a control device in a third operating mode in a further embodiment.

### DETAILED DESCRIPTION

The description of a first exemplary embodiment follows.

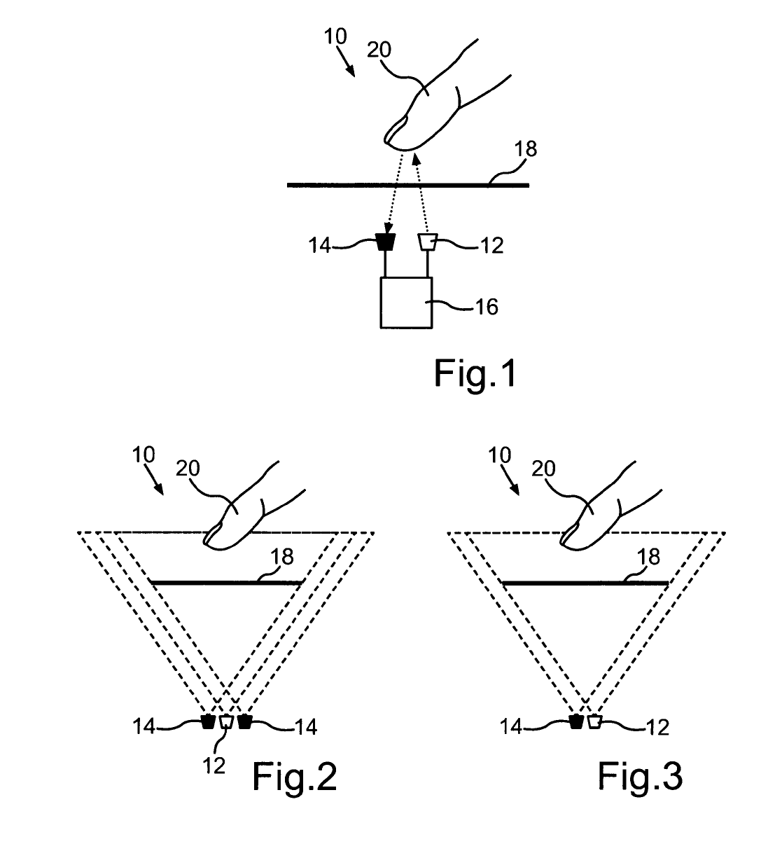

FIG. 1 shows a control device 10 for a motor vehicle according to the first exemplary embodiment in a schematic sliced side view. The control device 10 comprises a transmitter unit 12 and a receiving unit 14. The transmitter unit 12 and the receiving unit 14 are coupled to an evaluation unit 16. The transmitter unit 12, the receiving unit 14 and the evaluation unit 16 are arranged underneath a control surface element 18. A finger 20 can be spatially positioned to carry out a control input on the side of the control surface element facing away from the transmitter unit 12, the receiving unit 14 and the evaluation unit 16.

The transmitter unit 12 transmits a signal to the finger 20. The signal is reflected by the finger 20 and the reflected signal is received by the receiving unit 14. The evaluation unit 16 is formed in order to determine a spatial position of the finger 20 in relation to the control surface element 18 by means of the received signal. The transmitter unit 12 preferably transmits light in the infrared wavelength range as the signal. The control surface element 18 preferably has a high degree of transmission in this wavelength region.

The description of a second exemplary embodiment follows.

FIG. 2 shows a second exemplary embodiment of the control device 10. Here, the control device 10 comprises two receiving units 14, which are arranged at a distance to each other. The receiving unit 14 can be formed, for example, as a corresponding stereo camera, which comprises two lenses and two image sensors, which capture the finger 20 from different perspectives. The three-dimensional position of the finger 20 can be determined by means of the known distance between the two receiving units 14 by offsetting the images captured using the receiving units 14.

The description of a third exemplary embodiment follows.

FIG. 3 shows a third exemplary embodiment of the control device 10. Presently, the control device 10 comprises a transmitter unit 12 and a receiving unit 14. The transmitter unit 12 can be formed as a corresponding lighting unit. The receiving unit 14 can be formed as a so-called depth camera, which generally has only one lens. A special image sensor calculates the three-dimensional position of the finger 20 by means of the transmission time of the signal transmitted by the transmitter unit 12 and the signal received by the receiving unit 14.

Likewise, the receiving unit 14 can be formed as a mono camera in the third exemplary embodiment depicted in FIG. 3. Such a mono camera detects the intensity of the light reflected by the finger 20 pixel-by-pixel using its lens with the associated image sensor. Thus, the three-dimensional position of the finger 20 can be determined by means of the intensity distribution.

The description of the fourth exemplary embodiment follows.

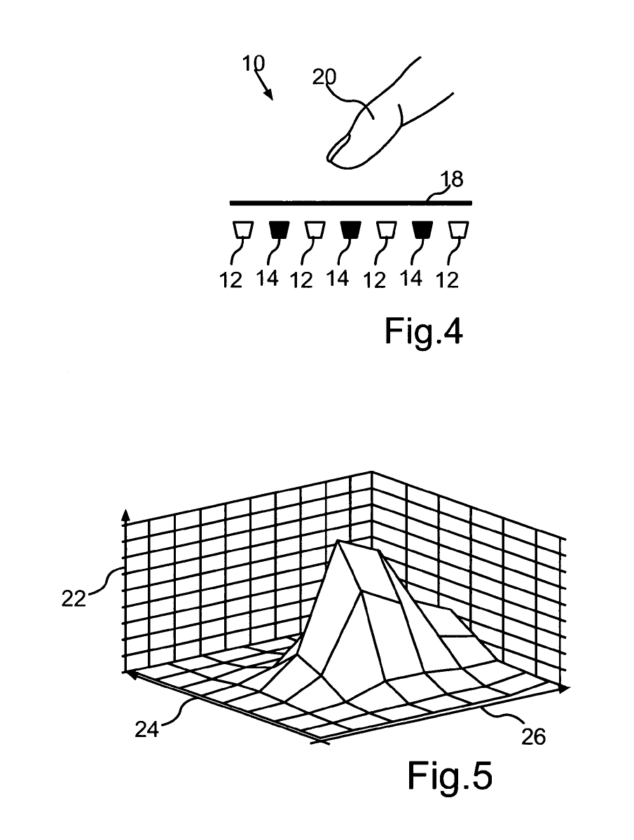

FIG. 4 shows a fourth exemplary embodiment of the control device 10, in which the control device 10 comprises a plurality of transmitter units 12 and a plurality of receiving units 14, which are arranged alternately and in parallel to the main extension direction of the control surface element 18. The transmitter units 12 can be formed as corresponding infrared transmitters, in particular as light diodes, and the receiving units 14 can be formed as infrared receivers, in particular as photo diodes. These can be arranged in a grid-like manner on a circuit board, which is not depicted here. Through the suitable controlling of the transmitter units 12 and the receiving units 14, the intensity of the reflected light can be measured pixel-by-pixel. The three-dimensional position of the finger 20 can be determined by means of the intensity distribution of the reflected light.

FIG. 5 shows a measurement signal of a control device 10 according to the first to fourth exemplary embodiments. The three-dimensional graph shows the distribution of the intensity of the light reflected by the finger, the light being detected with the receiving units 14. The axis 22 corresponds to a first extension direction and the axis 24 to a second extension direction that is perpendicular to the first extension direction. The extension directions run in parallel to the main extension direction of the control surface element 18. The coarse resolution of the intensity distribution depicted in FIG. 5, which is caused by the discreet construction or the arrangement of the transmitter units 12 and the receiving units 14, can be compared by a suitable interpolation of the measured data.

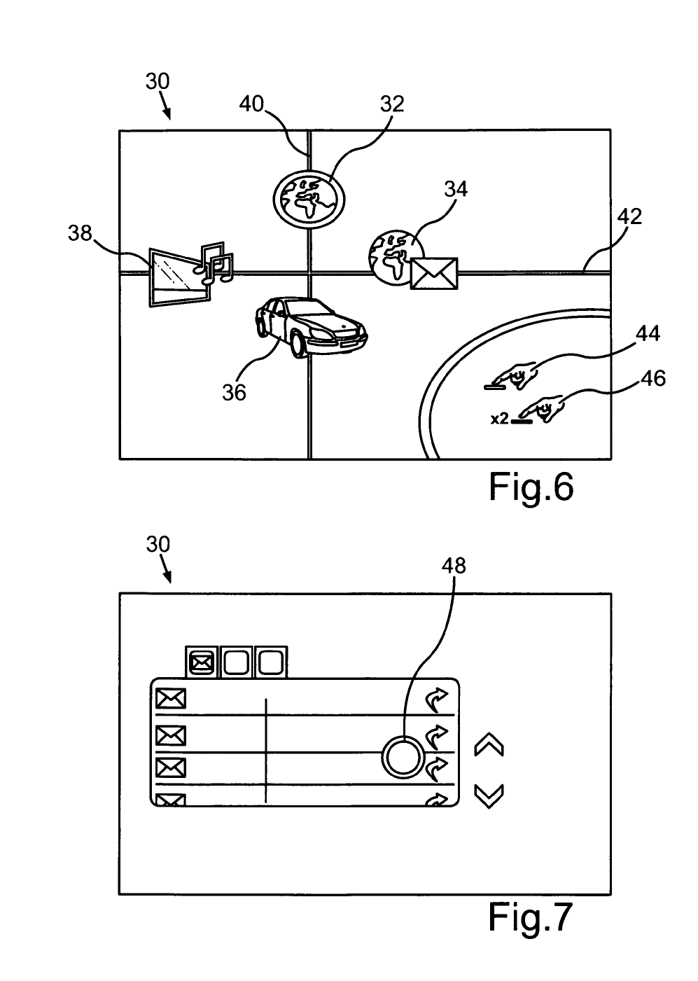

FIGS. 6 to 9 show different displays of a display element, which is allocated to a control device for a motor vehicle according to one of the preceding exemplary embodiments. As has already been described, this control device is formed to detect the position of a finger on and/or over a control surface element of the control device. The position of the finger, with which a control input is carried out, can thus be detected three-dimensionally in relation to the control surface element or a corresponding operating surface of the control device. Additionally, corresponding swipe movements can be carried out with the finger on the control surface element, which are recognized as an operational action. Furthermore, the control device comprises a corresponding sensor element, with which a pressure exerted with the finger on the operating surface can be detected.

To operate the control device, different operating modes are provided, which can be selected by the operator. Depending on the selected operating mode, a specifically depicted content is depicted on the display element, by means of which the operation can be carried out.

FIG. 6 shows a display 30 of a display element of the control device in the first operating mode. Presently, four selection elements in the form of symbols 32 to 38 are depicted on the display 30. Symbol 32 is allocated to a navigation system of the motor vehicle. Symbol 34 is allocated to an information and communication system of the vehicle. Symbol 36 is allocated to systems of the motor vehicle. Symbol 38 is allocated to an entertainment system of the motor vehicle. Presently, the symbols 32 to 38 are arranged in a so-called radial menu.

The operator can select one of the depicted symbols 32 to 28 and the function of the motor vehicle connected to it through a swipe movement, which they carry out on the operating surface of the control device. The swipe movement, which they carry out with the finger, occurs therein in the direction of the symbol 32 to 38, which they would like to select. The display 30 additionally shows corresponding lines 40 and 42, along which the swipe movement is to be carried out. Thus, for example, a swipe movement must be carried out along the line 40 from above to below to select the navigation system of the motor vehicle.

Additionally, gestures across all concepts are recognized in this first operating mode. Thus, for example, another level of the operating menu can be selected by the quick implementation of a circular movement with the finger on the control surface element. This previously described gesture is illustrated on the display 30 by symbol 44. Likewise, the gesture across all concepts can be provided, by means of which the main menu is called up by a quick double tap with the finger on the operating surface. This gesture across all concepts is also illustrated on the display 30 by the symbol 46.

FIG. 7 shows a display 30 of a display element of the control device in a second operating mode. The display 30 shows a depiction of an inbox of an e-mail program of the motor vehicle. Through the movement of the finger on the control surface element of the control device, a pointer 48, depicted using the display 30, can be moved, which is depicted presently as a circle. Thus, for example, the pointer 48 can be moved over a corresponding selection element, in the present case a received e-mail, and the selection element can be selected with a pressure of the finger on the control surface element. In this way, for example, the corresponding e-mail can be opened. Likewise, in a second operating mode, corresponding swiping gestures, which are carried out with the finger on the control surface element can be taken into account. Furthermore, corresponding list entries can be chosen between by means of the swiping gestures. Here, gestures across all concepts can also be taken into account.

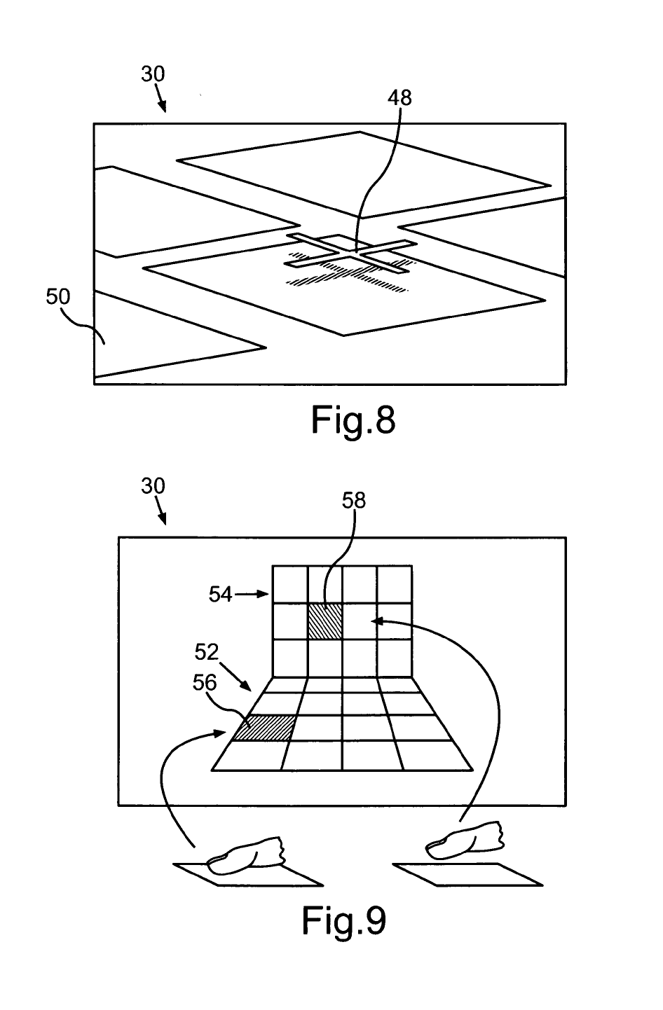

FIG. 8 shows a display 30 of the display element of the control device in a third operating mode. Herein, the individual selection elements are depicted perspectively in the form of surface elements 50. Thus, a corresponding pointer 48 is depicted perspectively in the display 30. The height of the pointer 48 in relation to the selection element 50 can be changed by the distance of the finger from the control surface element. In this operating mode it is also possible that corresponding selection elements 50 are selected, are lifted in the depiction and are displaced.

FIG. 9 shows a further display 30 of the display of a control device in the third operating mode. The display 30 shows an extended keyboard. The depiction of this keyboard is divided into two regions 52 and 54. Therein, a first key 56, which is arranged in the first region 52, can be operated by the finger being positioned on the control surface element. A second key 58, which is arranged in the second region 54, can be operated by the finger being positioned at a predetermined distance from the control surface element.

Although the present invention has been previously described by means of exemplary embodiments, it is understood that different embodiments and amendments can be carried out, without leaving the scope of the present invention, as is defined in the enclosed claims.

The disclosure of the drawing is explicitly referred to with regard to further features and advantages of the present invention.

1-18. (canceled)

19. A control device for a motor vehicle, wherein the control device detects a control input carried out by at least one finger, the control device comprising:
a transmitter unit configured to transmit a signal to the finger;
a receiving unit configured to receive a signal reflected by the finger;
a control surface element, in relation to which the finger is able to be spatially positioned to implement a control input; and
an evaluation unit configured to determine a spatial position of the finger in relation to the control surface element using the received signal.

20. The control device according to claim 19, wherein the control surface element is permeable to the signal, and the transmitter unit and the receiving unit are arranged on a side of the control surface element facing away from the finger.

21. The control device according to claim 19, wherein the transmitter unit is configured to transmit light in an infrared wavelength range as the signal.

22. The control device according to claim 19, wherein the evaluation unit is configured to determine the position of the finger using a transmission time of the signal.

23. The control device according to claim 19, wherein the evaluation unit is configured to determine the position of the finger using an intensity of the received signal.

24. The control device according to claim 19, wherein the receiving unit includes at least two receiving units arranged at a distance in a direction of extension parallel to a main direction of extension of the control surface element.

25. The control device according to claim 19, wherein the transmitting unit includes a plurality of transmitter units and the receiving unit includes a plurality of the receiving units, wherein the plurality of transmitting and receiving units are arranged in a first direction of extension and in a second direction of extension running perpendicularly to the first direction of extension, parallel to a main direction of extension of the control surface element.

26. The control device according to claim 19, further comprising:
a sensor unit configured to detect a touching of the control surface element with the finger.

27. The control device according to claim 26, wherein the transmitter unit and the receiving unit are activatatable depending on a signal of the sensor unit to determine the position of the finger.

28. The control device according to claim 19, further comprising:
an actuator configured to provide a haptic signal to the finger touching the control surface element.

29. A method for operating a control device for a motor vehicle, the method comprising:
detecting a control input carried out by at least one finger in relation to a control surface element;
determining which one of a first and second operating mode of the control device is selected;
performing an operation based on the control input and the selected operating mode; and
displaying, based on which one of the first and second operating modes is selected, content on a display element corresponding to the selected operating mode of the control device.

30. The method according to claim 29, wherein in the first operating mode, a selection element depicted on the display element is selected by a swipe movement of the finger carried out on the control surface element in a direction of the selection element.

31. The method according to claim 29, wherein in the second operating mode a pointer is positioned in a region allocated to a selection element by moving the finger on the control surface element and the selection element is selected by pressing on the control surface element with the finger.

32. The method according to claim 29, wherein in the second operating mode characters are inserted into a text processing program of the control device by moving the finger on the control surface element.

33. The method according to claim 29, wherein in a third operating mode of the control device the selection element depicted on the display element is depicted perspectively and, in this depiction a pointer depicted on the display element is changeable with regard to height depending on the distance of the finger to the operating surface.

34. The method according to claim 33, wherein in the third operating mode a size of a region depicted on the display element is changed depending on the distance of the finger from the control surface element.

35. The method according to claim 33, wherein in the third operating mode at least one first functional unit of the motor vehicle is operated by the distance of the finger from the control surface element and at the same time at least one second functional unit of the motor vehicle is operated depending on a movement of the finger along a direction of extension parallel to a main direction of extension of the control surface element.

36. The method according to claim 33, wherein in the third operating mode at least a first of the selection elements is operated when the finger is positioned on the control surface element or at least one second selection element is operated when the finger is positioned at a predetermined distance from the operating surface.
